(19) United States
(12) Patent Application Publication
(10) Pub. No.: US 2011/0316417 A1
(43) Pub. Date: Dec. 29, 2011

(54) LIGHT-EMITTING DIODE ILLUMINATION PLATFORM

(76) Inventor: Jen-Shyan Chen, Hsinchu City (TW)

(21) Appl. No.: 12/829,933

(22) Filed: Jul. 2, 2010

Related U.S. Application Data
(60) Provisional application No. 61/358,476, filed on Jun. 25, 2010.

(51) Int. Cl. F21V 29/00; F21V 23/00; H05B 37/02

(52) U.S. Cl. 315/32; 315/294; 315/113

(57) ABSTRACT

The invention discloses a light-emitting diode illumination platform. When the form factor and the driving current of the light-emitting diode illumination platform are almost fixed, the light-emitting diode illumination platform could includes a certain quantity of light-emitting diodes to be driven by the driving current to light, and if the light-emitting diode illumination platform alternatively includes more light-emitting diodes, the light-emitting diode illumination platform could be driven by the same driving current to light in higher illumination. Similarly, the light-emitting diode illumination platform could alternatively include light-emitting diodes with high luminous efficiency. Thereby, the light-emitting diode illumination platform of the invention with fixed structure size has the advantage of providing different illumination by equipping with different quantities of light-emitting diodes or with light-emitting diodes with different luminous efficiencies.

### BACKGROUND OF THE INVENTION

1. Field of the Invention

The present invention relates to a light-emitting diode (LED) illumination platform, and more particularly, to a LED illumination platform having a fixed form factor, wherein the LED illumination platform can further comprise LEDs with various amounts and various luminous efficiencies.

2. Description of the Prior Art

With the development of semi-conductor light emitting devices, a light-emitting diode (LED), which has several advantages such as power save, seismic resistance, quick reaction, and so on, becomes a new light source. In order to raise the intensity of light, high-power LED has been used as the light source in many illumination products. Although high-power LED can provide stronger light, it may also cause other problems related to heat dissipation. For example, if the heat generated by the LED cannot be dissipated in time, the LED will suffer from “heat shock” which may affect the luminous efficiency and reduce the work life of the LED.

Besides, the size of heat-dissipating component is usually relevant to the power of the corresponding LED. Therefore, when users want to replace low-power LEDs with high-power LEDs, it may have problems with engaging device for fixing the LEDs and the heat-dissipating component. For example, replacing the low-power LEDs with the high-power LEDs may very probably have interference problems; on the other hand, replacing the high-power LEDs with the low-power LEDs may not be firmly fixed where it should be.

### SUMMARY OF THE INVENTION

A scope of the invention is to provide a light-emitting diode illumination platform has a fixed form factor with a plurality of LEDs, and the LEDs comprise several types of luminous efficiency for providing different scales of illumination.

Within the scope of the invention, when the LED illumination platform has a form factor and is powered by a driving current, the LED illumination platform generates light within the range of X±10% lumens while driven by the drive current if the LED illumination platform comprises n units of first LEDs and the LED illumination platform generates light within the range of Y±10% lumens while driven by the drive current if the LED illumination platform comprises m units of the first LEDs; wherein if the LED illumination platform comprises n units of second LEDs the LED illumination platform generates light within the range of Y±10% lumens while driven by the drive current, and if the LED illumination platform comprises m units of the second LEDs the LED illumination platform generates light within the range of Z±10% lumens while driven by the drive current; wherein m>n, Z>Y, Y>X, and the luminous efficiency of the second LED is higher than that of the first LED.

According to an embodiment of the invention, the form factor of the LED illumination platform comprises a heat-pipe, a first heat-dissipating component, a second heat-dissipating component and an energy converter. The heat-pipe has a flat portion and a contact portion, and the contact portion extending along a direction. The first heat-dissipating component has a plurality of first fins, and the first fins are substantially parallel to the direction. The second heat-dissipating component is engaged with the first heat-dissipating component for forming a containing space, the contact portion is contained inside the containing space and contacted with the first heat-dissipating component and the second heat-dissipating component simultaneously. The energy converter is contacted with the flat portion, and comprises the first LEDs or the second LEDs, wherein the first heat-dissipating component comprises a first half cavity along the direction, and the second heat-dissipating component comprises a second half cavity along the direction, and the containing space is formed by the first half cavity and the second half cavity.

According to another embodiment of the invention, the form factor comprises a heat-pipe, a carrier, a first heat-dissipating component and an energy converter. The heat-pipe has a flat portion and a contact portion, and the contact portion extends along a direction. The carrier, connected to the heat-pipe, has a first surface which is coplanar with the surface of the flat portion of the heat-pipe. The first heat-dissipating component has a plurality of first fins, and the first heat-dissipating component is coupled the contact portion of the heat-pipe. The energy converter is contacted with the flat portion and is capable to accommodate the first LEDs or the second LEDs, and the energy converter is fixed on the carrier to contact with the flat portion.

The heat generated by the energy converter can be transmitted to the heat-pipe through the flat portion. Therefore, the heat in the heat-pipe can be dissipated by the first heat-dissipating component and the second heat-dissipating component. The heat-dissipating efficiency can also be enhanced by providing the first fins comprised in the first heat-dissipating component.

Within the scope of the invention, the LED illumination platform has a form factor and is powered by a driving current, the LED illumination platform generates light within the range of X±10% lumens while driven by the drive current if the LED illumination platform comprises n units of first LEDs and the LED illumination platform generates light within the range of Y±10% lumens while driven by the drive current if the LED illumination platform comprises m units of the first LEDs; wherein if the LED illumination platform comprises n units of second LEDs the LED illumination platform generates light within the range of Y±10% lumens while driven by the drive current, and if the LED illumination platform comprises m units of the second LEDs the LED illumination platform generates light within the range of Z±10% lumens while driven by the drive current; wherein m>n, Z>Y, Y>X, and the luminous efficiency of the second LED is higher than that of the first LED.

Continued from the preceding paragraph, the form factor comprises a heat-pipe, a carrier, a heat-dissipating component, an energy converter and a panel. The heat-pipe has a flat portion and a contact portion. The carrier with a opening accommodates the heat-pipe, the carrier has a first surface which is coplanar with the surface of the flat portion of the heat-pipe. The heat-dissipating component has a plurality of fins, and the heat-dissipating component is coupled to the contact portion of the heat-pipe. The energy converter is contacted with the flat portion and accommodates the first LEDs or the second LEDs, the energy converter is fixed on the carrier to contact with the flat portion. The panel with a hole corresponds to the energy converter, the heat pipe and the heat-dissipating component are disposed in one side of the panel, and the light emitted from the energy converter projects toward the other side of the panel.

The advantage and spirit of the invention may be understood by the following recitations together with the appended drawings.

### BRIEF DESCRIPTION OF THE APPENDED DRAWINGS

FIG. 1 illustrates a schematic of a LED illumination platform according to a first preferred embodiment of the invention.

FIG. 2 illustrates a cross section view of the LED illumination platform 1 according to FIG. 1.

FIG. 3A illustrates a schematic of a first heat-dissipating component according to an embodiment of the invention.

FIG. 3B illustrates a schematic of a tube body of second heat-dissipating component according to an embodiment of the invention.

FIG. 4A illustrates a schematic of an optical modulator being screwed onto a carrier by a thread structure according to an embodiment of the invention.

FIG. 4B illustrates a schematic of the optical modulator being inset to the carrier by a hook structure according to an embodiment of the invention.

FIG. 4C illustrates a schematic of the hook structure of the optical modulator and a groove of the carrier according to an embodiment of the invention.

FIG. 5 illustrates a schematic of the carrier being screwed onto a heat-pipe by a thread structure according to an embodiment of the invention.

FIG. 6A illustrates a top view of the energy converter and the carrier according to an embodiment of the invention.

FIG. 6B illustrates a sectional view of the energy converter, the carrier, and a part of the heat-pipe along Z-Z line in FIG. 3A.

FIG. 7 illustrates a cross section of the energy converter, the carrier, and a part of the heat-pipe according to an embodiment.

FIG. 8 illustrates a cross section view of the energy converter, the carrier, and a part of the heat-pipe according to another embodiment.

FIG. 9 illustrates a cross section view of the energy converter, the carrier, and a part of the heat-pipe according to another embodiment.

FIG. 10 illustrates a cross section view of the energy converter, the carrier, and a part of the heat-pipe according to another embodiment.

FIG. 11 illustrates a schematic of a LED illumination platform according to a second preferred embodiment of the invention.

FIG. 12A illustrates a schematic of the first heat-dissipating component according to an embodiment of the invention.

FIG. 12B illustrates a schematic of the second heat-dissipating component according to an embodiment of the invention.

FIG. 13A illustrates a schematic of a LED illumination platform according to a third preferred embodiment of the invention.

FIG. 13B illustrates a partial cross section of a LED illumination platform according to FIG. 13A.

### DETAILED DESCRIPTION OF THE INVENTION

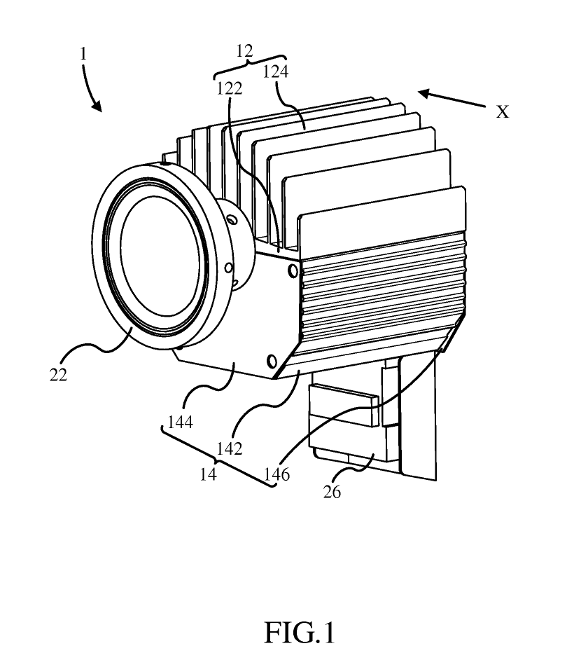

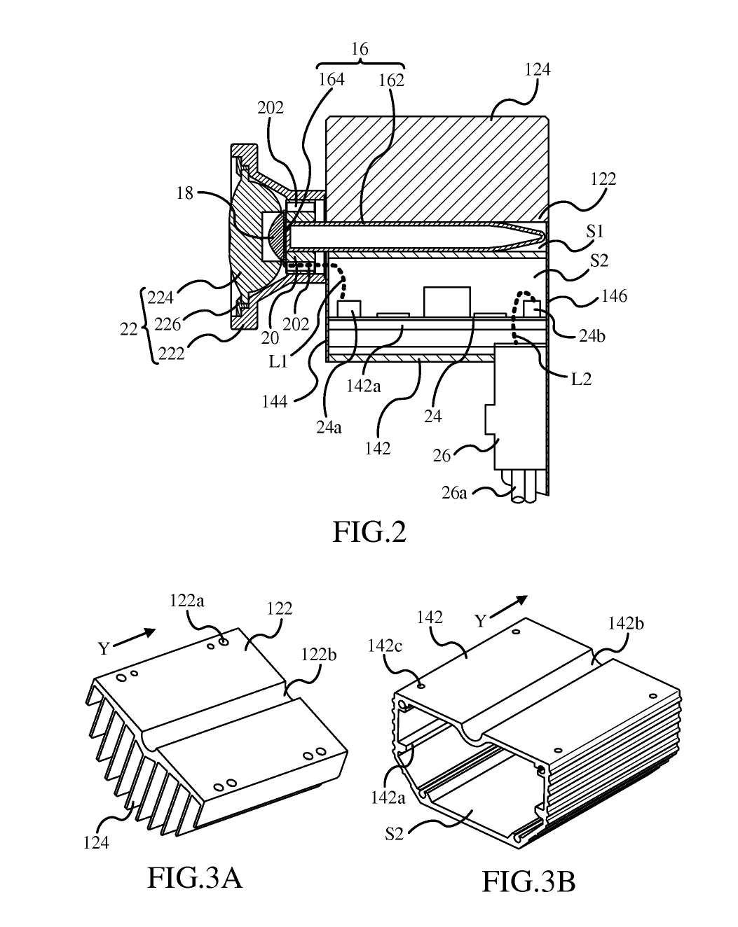

Please refer to FIG. 1 and FIG. 2. FIG. 1 illustrates a schematic of a LED illumination platform according to a first preferred embodiment of the invention.

FIG. 2 illustrates a cross section view of the LED illumination platform 1 according to FIG. 1. Specifically, the viewpoint of FIG. 2 is defined as direction X in FIG. 1. In order to simplify the drawing, the control module circuit 24 and the connector 26 are not drawn in the cross section view, and the energy converter 18 has also been simplified.

When the LED illumination platform 1 has a form factor and is powered by a driving current, the LED illumination platform 1 generates light within the range of X±10% lumens while driven by the drive current if the LED illumination platform 1 comprises n units of first LEDs and the LED illumination platform 1 generates light within the range of Y±10% lumens while driven by the drive current if the LED illumination platform 1 comprises m units of the first LEDs; wherein if the LED illumination platform 1 comprises n units of second LEDs the LED illumination platform 1 generates light within the range of Y±10% lumens while driven by the drive current, and if the LED illumination platform 1 comprises m units of the second LEDs the LED illumination platform 1 generates light within the range of Z±10% lumens while driven by the drive current; wherein m>n, Z>Y, Y>X, and the luminous efficiency of the second LED is higher than that of the first LED.

Continued from the preceding paragraph, the LED illumination platform 1 could includes a certain quantity of LEDs to be driven by the driving current to light, and if the LED illumination platform 1 alternatively includes more LEDs, the LED illumination platform 1 could be driven by the same driving current to light in higher illumination. Similarly, the LED illumination platform 1 could alternatively include LEDs with high luminous efficiency. Thereby, the LED illumination platform 1 of the invention with fixed structure size has the advantage of providing different illumination by equipping with different quantities of LEDs or with LEDs with different luminous efficiency

Corresponding to different situations, the factor X, Y, Z, m, and n can change accordingly, for example, m=6, n=4, X=350, Y=500, Z=700; m=6, n=4, X=500, Y=700, Z=1000; m=6, n=4, X=700, Y=1000, Z=1400; m=8, n=6, X=700, Y=1000, Z=1400; m=8, n=6, X=1000, Y=1400, Z=2000; wherein the drive current is approximately 530 mA. In practice, the driven current shall tally with specifications of LEDs, the factors are not limited to those examples mentioned above. Obviously, the LED illumination platform 1 is not necessary to be redesigned for providing different scales of illumination, that is, the LED illumination platform 1 can be improved under the fixed form factor.

According to the first preferred embodiment, the form factor of the LED illumination platform 1 includes a first heat-dissipating component 12, a second heat-dissipating component 14, a heat-pipe 16, an energy converter 18, a carrier 20, an optical modulator 22, a control module circuit 24, and a connector 26. The first heat-dissipating component 12 includes a plate body 122 and several fins 124 extending from the plate body 122. The second heat-dissipating component 14 includes a tube body 142, a front lid 144, and a back lid 146. The front lid 144 and the back lid 146 are engaged to two openings of the tube body 142 to form a circuit housing S2. The circuit housing S2 accommodates the control module circuit 24 and a part of the connector 26. The control module circuit 24 is disposed on a protrusion 142a of the tube body 142 (please refer to FIG. 3B). Additionally, if the protrusion 142a is formed to be a slide, it is helpful to mounting the control module circuit 24.

The first heat-dissipating component 12 and the second heat-dissipating component 14 are engaged together and form a containing space S1. The shape of the containing space S1 is a cylinder nearly for accommodating the heat-pipe 16. The heat-pipe 16 includes a contact portion 162 and a flat portion 164. The contact portion 162 is disposed in the containing space S1 and contacts with the first heat-dissipating component 12 and the second heat-dissipating component 14. Additionally, other substances with high thermal conductivity could replace the heat-pipe 16.

The carrier 20 is mounted at an end of the heat-pipe 16. In principle, the carrier 20 and the flat portion 164 of the heat-pipe 16 are coplanar but not limited to it. The energy converter 18 is mounted on the carrier 20 and contacts with the flat portion 164, so that the heat generated in operation by the energy converter 18 could be conducted through the flat portion 164 to the heat-pipe 16, then conducted through the contact portion 162 of the heat-pipe 16 to the first heat-dissipating component 12 (including the fins 124 thereof) and the second heat-dissipating component 14, and dissipated outside. The optical modulator 22 includes a ring body 222, a lens structure 224, and a fixed ring 226. The ring body 222 is connected to the carrier 20, the lens structure 224 is disposed right opposite to the energy converter 18, and the fixed ring 226 is mounted on the ring body 222.

Moreover, the control module circuit 24 includes a circuit board and other related electronic devices. The control module circuit 24 is electrically connected to the energy converter 18 by a wire L1 (represented by a bold-faced dotted line in FIG. 2) which is electrically connected to a connector 24a. The carrier 20 thereon forms holes 202 for the wire to pass through. The control module circuit 24 is electrically connected to the connector 26 (e.g. terminal blocks) through a wire L2 (represented by a bold-faced dotted line in FIG. 2) which is electrically connected to a connector 24b. According to the conversion mode of the energy converter 18, the connector 26 is connected to a power source through a wire 26a to obtain the required electricity for controlling the operation of the energy converter 18 by the control module circuit 24; for example, the conversion mode is to transduce electricity into photo energy (e.g. the energy transduction of LEDs). The connector 26 could alternatively provide electricity to other devices via the wire 26a; for example, the conversion mode is to transduce photo energy into electricity (e.g. the energy transduction of a solar cell).

Please refer to FIG. 3A and FIG. 3B. FIG. 3A illustrates the first heat-dissipating is component 12. Relative to the LED illumination platform 1 in FIG. 1, the first heat-dissipating component 12 illustrated in FIG. 3A has been turned over for explaining conveniently. FIG. 3B illustrates the tube body 142 of the second heat-dissipating component 14. As shown in FIG. 3A and FIG. 3B, the plate body 122 of the first heat-dissipating component 12 includes a first half cavity 122b which is a semicircle and extends along Y direction; the tube body 142 of the second heat-dissipating component 12 correspondingly includes a second half cavity 142b which is a semicircle and extends along Y direction. When the first heat-dissipating component 12 is connected to the second heat-dissipating component 14, the first half cavity 122b and the second half cavity 142b therefore form the containing space S1.

In practical fabrication, the heat-pipe 16 could be disposed in the first half cavity 122b or the second half cavity 142b. Then, the plate body 122 and the tube body 142 are connected by screwing screws through holes 122a into threaded holes 142c, and the first heat-dissipating component 12 and the second heat-dissipating component 14 are therefore connected. The heat-pipe 16 is also accommodated in the containing space S1 formed by the first half cavity 122b and the second half cavity 142b. The mounting method for the invention is not limited to the above-mentioned method. Therefore, they (the plate body 122 and the tube body 142) could also be mounted together by welding or a C-shaped buckle.

If the outer diameter of the heat-pipe 16 is little smaller than the inner diameter of the containing space S1 or the cross-sectional profile of the heat-pipe 16 interfere in dimensions with the cross-sectional profile of the containing space S1, the contact portion 162 of the heat-pipe 16, by above-mentioned fabrication, will be compressed to paste on the first heat-dissipating component 12 and the second heat-dissipating component 14 tightly. Therefore, the heat-pipe 16 will be deformed, which could not only enhance the connection strength of the heat-pipe 14 to both the first heat-dissipating component 12 and the second heat-dissipating component 14 but also increase the contact area of the contact portion 162 to both the first half cavity 122b and the second half cavity 142b, so as to increase the thermal conduction efficiency.

Additionally, both the first half cavity 122b and the second half cavity 142b do not have to occupy the containing space S1 equally. In other words, the first half cavity 122b could occupy most of the containing space S1. For example, if the cross-section of the heat-pipe 16 is a rectangle, the appearance of the second half cavity 142b presents a plane substantially (i.e. the second heat-dissipating component 12 has the unobvious second half cavity 142b) and the second half cavity 142b still could form the containing space S1 together with the first half cavity 122b. Therefore, it is enough that the first heat-dissipating component 12 is engaged to the second heat-dissipating component 14 to form the containing space S1. It is not necessary that both the first heat-dissipating component 12 and the second heat-dissipating component 14 have a concave and protrusive structure.

Additionally, although the direction Y is a linear direction, it is not limited to this. It could also be a curve. Logically, a connection plane of the first heat-dissipating component 12 and the second heat-dissipating component 14 is a parting plane of the containing space S1 for dividing the containing space S1 into the first half cavity 122b and the second half cavity 142b. In principle, if the containing space S1 extends along a curve, the curve lies on the parting plane. In the first preferred embodiment, the fins 124 are parallel to the direction Y. Although the LED illumination platform 1 (or the heat-pipe 16) is disposed vertically or horizontally, air could flow through the intervals of the fins 124 fluently. Incidentally, each of the fins 124 could also be arranged radially.

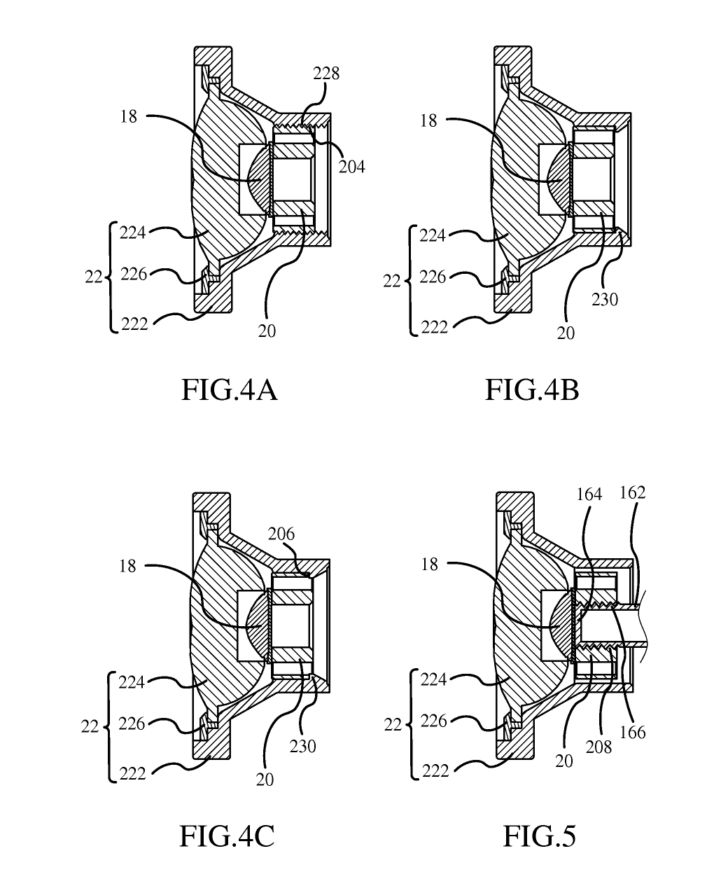

Moreover, the ring body 222 of the optical modulator 22 as shown in FIG. 2 could be mounted on the carrier 20 by pasting, clamping or screwing a screw through the ring body 222 into the carrier 20; however, the fixation of the invention is not limited to it. Please refer to FIG. 4A and FIG. 4B. FIG. 4A illustrates that the optical modulator 22 is screwed on the carrier 20 by a thread structure. FIG. 4B illustrates that the optical modulator 22 hooks the carrier 20 by a hook structure. As shown in FIG. 4A, the thread structure primarily consists of an inner thread 228 formed in the ring body 222 and an outer thread 204 formed on a side of the carrier 20. Thus, the ring body 222 of the optical modulator 22 could be screwed on the carrier 20. Additionally, the thickness of the wall of the thread structure in the carrier 20 is different form that shown in FIG. 2, because the modification for the different connection structure is required.

As shown in FIG. 4B, the hook structure could consists of a hook 230 formed on the ring body 222. The optical modulator 22 could be connected to the carrier 20 by hooking the carrier 20 with the hook 230. If a hook slot 206 is formed on the carrier 20 correspondingly, the hook structure consists of the hook 230 and the hook slot 206. When the hook 230 of the optical modulator 22 has hooked the hook slot 206 of the carrier 20, the position of the hook 230 is also limited in the hook slot 206 as shown in FIG. 4C. With a proper design of size, the hook slot 206 is able to mount the hook 230 thereon.

Moreover, the carrier 20 shown in FIG. 2 could be mounted at an end of the heat-pipe 16 and against the heat-pipe 16 by the way of pasting, clamping, or screwing with a screw on the carrier 20; however, the fixation of the invention is not limited to these. Please refer to FIG. 5. FIG. 5 illustrates that the carrier 20 is screwed on the heat-pipe 16 through a thread structure. As shown in FIG. 5, the thread structure primarily consists of an inner thread 208 formed in a hole of the carrier 20 and an outer thread 166 formed on the heat-pipe 16. Thus, the carrier 20 could be screwed at an end of the heat-pipe 16.

Additionally, if the thickness of wall of the heat-pipe 16 is thick enough, the outer thread 166 of the heat-pipe 16 could be tapped by a traditional tapper. If the thickness of the heat 16 is not able to bear the cutting force or the thickness of wall after the cutting is not able to be screwed by the carrier 20, the outer screw thread 166 could be formed by rolling The formation could be to form the outer thread 166 with a slight change of the thickness of the wall, and the strength of the outer thread 166 is improved due to the effect of work hardening. It is noticed that FIG. 4A, FIG. 4B, FIG. 4C, and FIG. 5 only illustrate a sketch drawing of the energy converter 18 and the details of the energy converter 18 are not shown in these figures.

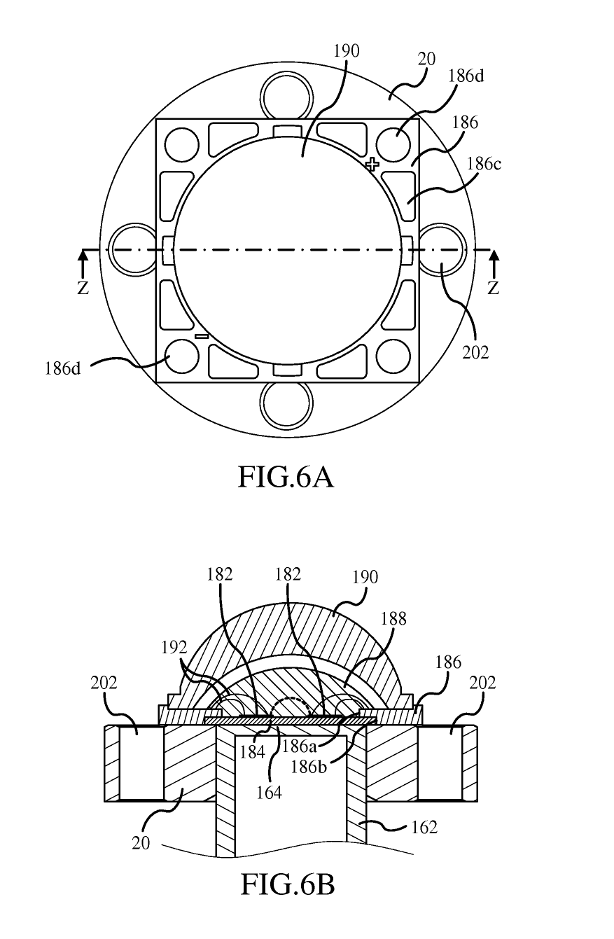

Please refer to FIG. 6A and FIG. 6B. FIG. 6 illustrates a plane view of the energy converter 18 and the carrier 20 of the LED illumination platform 1. FIG. 6B illustrates a cross section of the energy converter 18, the carrier 20, and a part of the heat-pipe 16 along line Z-Z in FIG. 6A. According to the first preferred embodiment, the energy converter 18 includes energy transducing semiconductor structures 182, a substrate 184 and a base 186. The energy transducing semiconductor structures 182 are disposed on the substrate 184. The base 186 includes a first sunken portion 186a and a second sunken portion 186b connected to the first sunken portion 186a. The substrate 184 contacts the flat portion 164 and is connected to the second sunken portion 186b, and the energy transducing semiconductor structure 182 are exposed out of the first sunken portion 186a.

The energy transducing semiconductor structure 182 is an independent chip and it is mounted on the substrate 184. The energy transducing semiconductor structure 182 is wired to inner electrodes of the base 186 with metal wires 192 and then the energy transducing semiconductor structure 182 is electrically connected to the control module circuit 24 through wires L1 welded to outer electrodes 186c which is connected to the inner electrodes on the base 186 (please also refer to FIG. 2). The energy transducing semiconductor structure 182 and metal wires 192 are mounted or sealed on the substrate 184 by a packing material 188. The base 186 is mounted on the carrier 20 by screwing screws through holes 186d to the carrier 20. The packing material 188 is also able to adjust light. If the contour of the packing material 188 is protrusive as shown in FIG. 6B, the packing material 188 is able to converge light.

According to the first preferred embodiment, the energy converter 18 includes a lens 190 disposed on the base 186. The lens 190 is able to converge light, but not limited to it. With a proper design on the curvatures of two sides of the lens 190, the lens 190 is able to converge or scatter light for satisfying different optical adjustment requirements. In practical application, the optical adjustment effect of the LED illumination platform 1 also need to consider optical characters of a lens structure 224 of the optical adjusting member 22. What is remarkable is that the lens structure 224 of the optical adjusting member 22 is not limited to a convex lens. Please refer to FIG. 4A, there is a recess at the middle of the lens structure 224 and thus light is converged to become a ring shape roughly by the lens structure 224.

Please refer to FIG. 6A and FIG. 6B. Additionally, the base 186 could be formed by imbedding a lead frame of metal into a mold and then injecting liquid crystal plastic into the mold. Therein, the inner electrodes defined on the lead frame are exposed out of the first sunken portion 186a, and the outer electrodes 186c are exposed out of the base 186. Additionally, the energy transducing semiconductors 182 could be connected in serial by wiring as shown by the dotted line in FIG. 6B. Meantime, the energy transducing semiconductor structure 182 in FIG. 6B only retains one metal wire 192 to be connected to the base 186. If there is a circuit on the substrate 184, for example a semiconductor substrate with a circuit formed in process or a circuit board coated with a metal circuit, the energy transducing semiconductor structure 182 could be wired to the substrate 184 and then electrically connected to the base 186 through the substrate 184. If the substrate 184 is designed not to be a medium for electrical connection, the substrate 184 could be made of a metal material or other materials with high thermal conductivity for raising the thermal conduction efficiency of conducting the heat generated by the energy transducing semiconductor structure 182 to the flat portion 164.

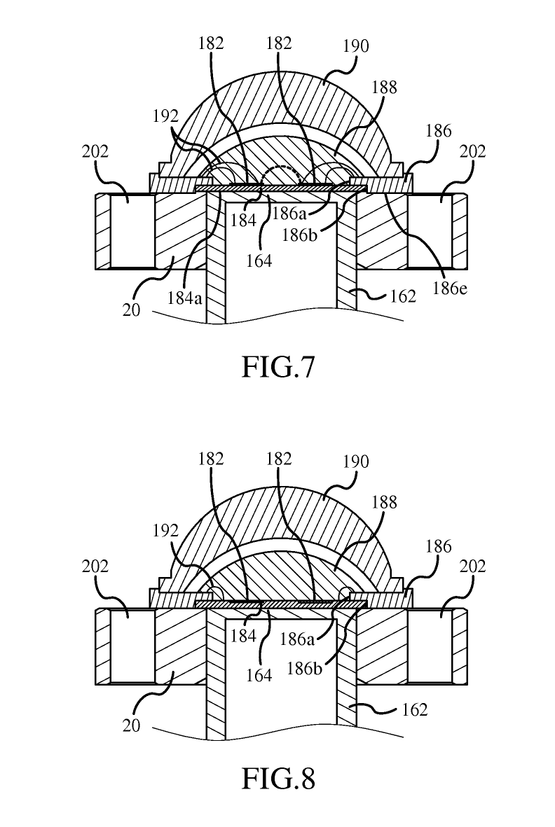

Please refer to FIG. 7. FIG. 7 illustrates a cross section of the energy converter 18, the carrier 20, and a part of heat-pipe 16 according to an embodiment. The difference between the FIG. 7 and FIG. 6 is that the substrate 184 in FIG. 7 is disposed in the second sunken potion 186b entirely. Therefore, the bottom surface 186e of the base 186 slightly protrudes out of the bottom surface 184a (for contacting with the flat portion 164) of the substrate 184. Correspondingly, the flat portion 164 protrudes out of the carrier 20 and the protrusive height of the flat portion 164 is slightly greater than the concave depth of the bottom surface 184a of the substrate 184 for ensuring that the substrate 184 is stuck on the flat portion 164 tightly.

Similarly, the flat portion 164 could slightly protrude out of the carrier 20 and the bottom surface 186e of the base 186 and the bottom surface 184a of the substrate 184 are coplanar. The above purpose for ensuring sticking tightly could also be achieved. In the structure shown in FIG. 6B, if there is a gap between the base 184 and the flat portion 164, a thermal conductive glue could be coated on the bottom surface of the base 186 or the flat portion 164 to be filled with the gap. Of course, in the structure as shown in FIG. 7, the thermal conductive glue could be coated on the bottom surface 186e of the base 186 or the flat portion 164 to be filled with the gap formed due to surface roughness of the bottom surface 186e or the flat portion 164.

Please refer to FIG. 6B and FIG. 8. FIG. 8 illustrates a cross section of the energy converter 18, the carrier 20, and a part of the heat-pipe 16 according to another embodiment. The difference between FIG. 6B and FIG. 8 is that the energy transducing semiconductor 182 in FIG. 8 is formed on the substrate 184 directly; for example, the substrate 184 itself is a semiconductor substrate (a silicon substrate). Therefore, the energy transducing semiconductor 182 could be integrated to form on the substrate 184 easily in a semiconductor process. Additionally, the electrodes of the energy transducing semiconductor structure 182 formed on the semi-substrate 184 could be integrated on the substrate 184 in advance, so that only two times of wiring are required to the energy transducing semiconductor structure 182. The stability of the fabrication could increase thereby.

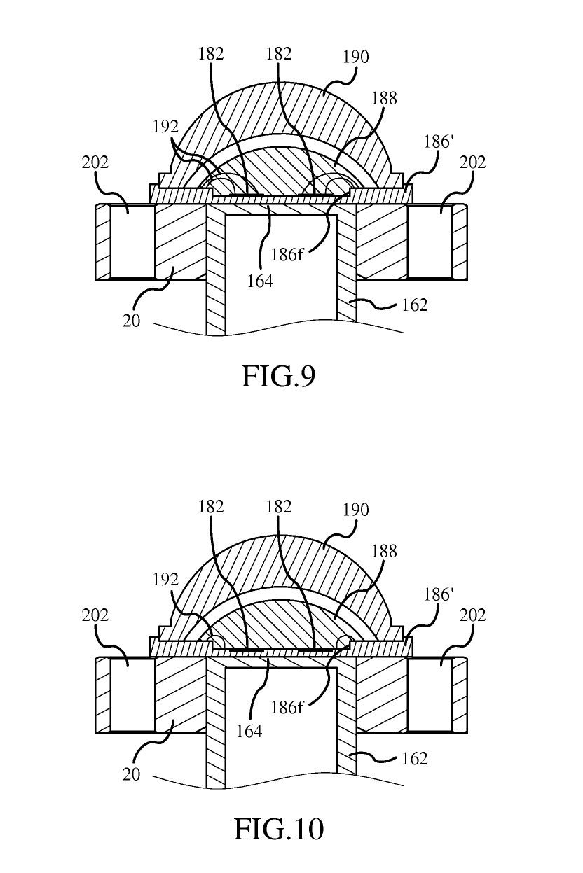

Please refer to FIG. 6B and FIG. 9. FIG. 9 illustrates a cross section of the energy converter 18, the carrier 20, and a part of the heat-pipe 16 according to another embodiment. The difference between FIG. 9 and FIG. 6B is that the energy transducing semiconductor structure 182 in FIG. 9 is disposed directly on a base 186′ having a recess 186f rather than on the substrate 184 as shown in FIG. 6B. Additionally, in practical application, the base 186′ could be a plate where the energy transducing semiconductor 182 is disposed directly. The description about the energy converter 18 in FIG. 6B is also applied here, and it will no longer be explained.

Please refer to FIG. 9 and FIG. 10. FIG. 10 illustrates a cross section of the energy converter 18, the carrier 20 and a part of the heat-pipe 16 according to another embodiment. The difference between FIG. 6B and FIG. 10 is that the energy transducing semiconductor structure 182 in FIG. 10 is formed directly on a base 186′. Of course, in practical application, the base 186′ could be a plate. The description about the energy converter 18 in FIG. 8 is also applied here, and it will no longer be explained.

Please refer to FIG. 1, FIG. 2, and FIG. 11. The FIG. 11 illustrates an LED illumination platform 3 according to a second preferred embodiment. The difference between the LED illumination platform 1 shown in FIG. 1 and the LED illumination platform 3 is that the second heat-dissipating component 14 and the first heat-dissipating component 12 (including a plate 142′ and fins 148 extended from the plate 142′) of the LED illumination platform 3 are symmetrical. Because the second heat-dissipating component 14 of the LED illumination platform 3 does not include the circuit housing S2 (as shown in FIG. 2) for accommodating the control module circuit 24, the LED illumination platform 3 does not include the control module circuit 24 and the connector 26 in principle. However, the LED illumination platform 3 could be connected to an electrical box at a rear end (relative to the front end where the optical adjusting member 22 is disposed) of the first heat-dissipating component 12 and the second heat-dissipating component 14 for accommodating the control module circuit 24 and the connector 26.

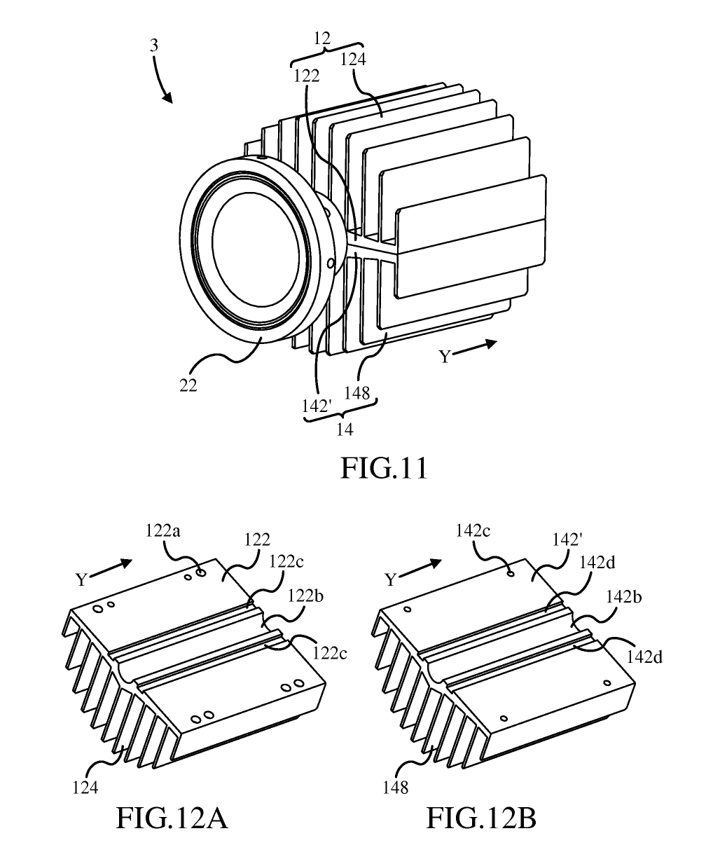

Please refer to FIG. 12A and FIG. 12B. FIG. 12A and FIG. 12B illustrates the first heat-dissipating component 12 and the second heat-dissipating component 14 respectively. Although the second heat-dissipating component 14 does not include the circuit housing S2 of the LED illumination platform 1, the first heat-dissipating component 12 and the second heat-dissipating component 14 of the LED illumination platform 3 include semi-channels 122c and 142d respectively. After the first heat-dissipating component 12 is engaged to the second heat-dissipating component 12, two channels are formed thereby for wires electrically connected to the energy converter 18 to pass through. If any description about devices with same names in the above-mentioned embodiments could be applied to the second preferred embodiment, the description is also applied here. It is no longer to be explained.

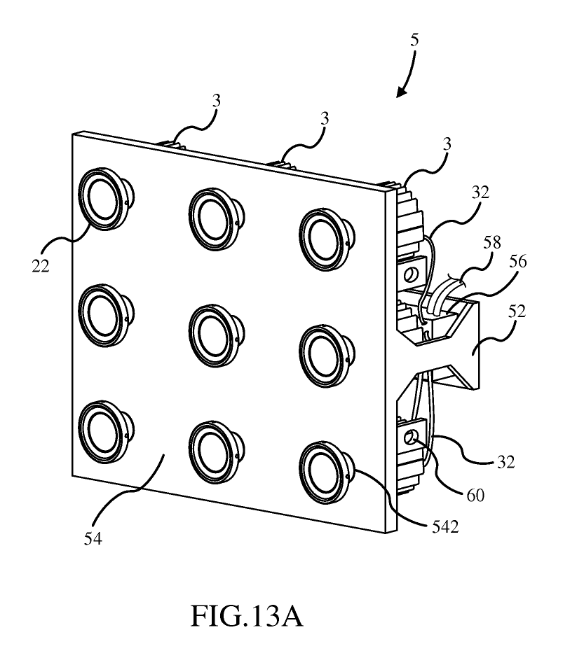

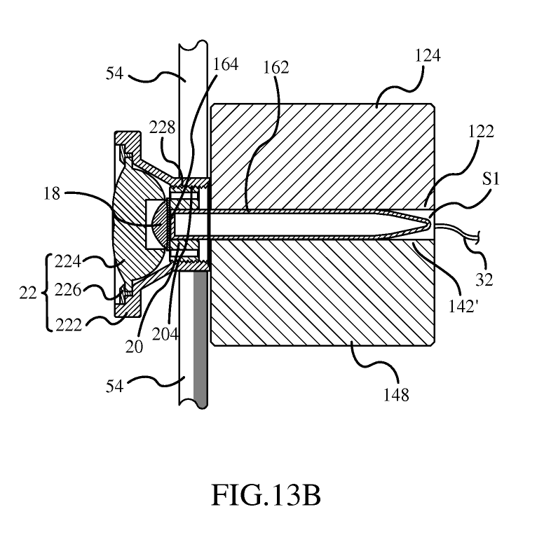

Please refer to FIG. 13A and FIG. 13B. FIG. 13A illustrates an energy transducing equipment 5 according to a third preferred embodiment. FIG. 13B illustrates a partial cross section of the energy transducing equipment 5 and it only illustrates the relative structure of the LED illumination platform 3 and a panel 54. The energy transducing equipment 5 includes a frame 52 and several LED illumination platforms 3 fixed on the frame 52. In other words, the energy transducing equipment 5 is a group of the LED illumination platforms.

The frame 52 includes a panel 54 which includes several holes 542 corresponding to the several LED illumination platforms 3. An outer thread 204 of the carrier 20 of each of the LED illumination platforms 3 is exposed out of the corresponding hole 542. Thus, the inner thread 228 of the optical adjusting member 22 of each of the LED illumination platforms 3 could be engaged with the outer thread 204 from the outside of the panel 54. The LED illumination platform 5 includes a control module circuit 56 which is mounted on the frame 52 and is electrically connected to the LED illumination platforms 3 through wires 32. Therefore, the LED illumination platforms 3 share the same circuit control circuit 56. The control module circuit 56 is electrically connected to an outer power supply through a wire 58 for obtaining required electricity or providing electricity to other apparatuses. Additionally, the frame 52 could be mounted on other mounts through a mounting portion 60.

Additionally, although the energy transducing equipment 5 includes a control module circuit 56, the framework of the energy transducing equipment 5 also suits for the LED illumination platform 1 (Please refer to FIG. 1). Because the LED illumination platform 1 has the individual control module circuit 24, the control functions of the control module circuit 56 could be simplified thereby. Moreover, it is not necessary for the energy transducing equipment 5 to include the LED illumination platforms 3 with the same energy conversion mode. In other word, the energy transducing equipment 5 could include some LED illumination platforms 3 with higher illumination and some LED illumination platforms 3 with lower illumination which are disposed in certain patterns for providing various luminous effects. In this case, the claimed form factor of this invention shows the characteristic that the LED illumination platforms 3 with different luminous efficiencies can be disposed, adjusted or replaced randomly on the holes 542 of the panel 54.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A light-emitting diode (LED) illumination platform characterized in that:
the LED illumination platform has a form factor and is powered by a driving current, the LED illumination platform generates light within the range of X±10% lumens while driven by the drive current if the LED illumination platform comprises n units of first LEDs and the LED illumination platform generates light within the range of Y±10% lumens while driven by the drive current if the LED illumination platform comprises m units of the first LEDs;
wherein if the LED illumination platform comprises n units of second LEDs the LED illumination platform generates light within the range of Y±10% lumens while driven by the drive current, and if the LED illumination platform comprises m units of the second LEDs the LED illumination platform generates light within the range of Z±10% lumens while driven by the drive current; wherein m>n, Z>Y, Y>X, and the luminous efficiency of the second LED is higher than that of the first LED.

2. The LED illumination platform of claim 1, wherein the form factor comprises:
a heat-pipe having a flat portion and a contact portion, and the contact portion extending along a direction;
a carrier connected to the heat-pipe, the carrier having a first surface which is coplanar with the surface of the flat portion of the heat-pipe;
a first heat-dissipating component having a plurality of first fins, and the first heat-dissipating component coupling the contact portion of the heat-pipe; and
a energy converter being contacted with the flat portion and capable to accommodate the first LEDs or the second LEDs, and the energy converter is fixed on the carrier to contact with the flat portion.

3. The LED illumination platform of claim 1, wherein the form factor comprises:
a heat-pipe having a flat portion and a contact portion, and the contact portion extending along a direction;
a first heat-dissipating component having a plurality of first fins, and the first fins being substantially parallel to the direction;
a second heat-dissipating component, engaged with the first heat-dissipating component, for forming a containing space, the contact portion being contained inside the containing space and being contacted with the first heat-dissipating component and the second heat-dissipating component simultaneously; and
an energy converter, being contacted with the flat portion, comprising the first LEDs or the second LEDs;
wherein the first heat-dissipating component comprises a first half cavity along the direction, and the second heat-dissipating component comprises a second half cavity along the direction, and the containing space is formed by the first half cavity and the second half cavity.

4. The LED illumination platform of claim 3, wherein the second heat-dissipating component comprises a plurality of second fins, and the second fins being substantially parallel to the direction.

5. The LED illumination platform of claim 3, wherein the second heat-dissipating component comprises a circuit housing for containing a control module circuit which controls the energy converter.

6. The LED illumination platform of claim 5, wherein the form factor further comprises a connector, being exposed outside the second heat-dissipating component, for being electrically connected to the control module circuit.

7. The LED illumination platform of claim 5, wherein the second heat-dissipating component comprises a tube body, a front lid and a back lid, and the front lid and the back lid are engaged to both ends of the tube body to form the circuit housing.

8. The LED illumination platform of claim 3, wherein the energy converter further comprises a substrate and a base, the first LEDs or the second LEDs are disposed on the substrate, and the substrate is connected to the base for exposing the first LEDs or the second LEDs.

9. The LED illumination platform of claim 8, wherein the base comprises a first depression portion and a second depression portion connected to the first depression portion, the substrate is contacted with the flat portion and accommodated by the second depression portion, the first LEDs or the second LEDs are exposed to the first depression portion.

10. The LED illumination platform of claim 3, wherein the energy converter comprises a base, and the first LEDs or the second LEDs are disposed on the base which contacts the flat portion of the heat-pipe.

11. The LED illumination platform of claim 10, wherein the base comprises a recess, and the first LEDs or the second LEDs are disposed on the recess.

12. The LED illumination platform of claim 3, wherein the form factor further comprises a carrier connected to the heat-pipe, and the energy converter is fixed on the carrier to contact with the flat portion.

13. The LED illumination platform of claim 12, wherein the form factor further comprises an optical modulator accommodating the energy converter.

14. The LED illumination platform of claim 12, wherein the carrier comprises a thread structure disposed on the carrier for screwing the optical modulator onto the carrier.

15. The LED illumination platform of claim 12, wherein the optical modulator is inset to the carrier by a hook structure.

16. The LED illumination platform of claim 12, wherein the optical modulator comprises a lens structure aligned with the energy converter.

17. The LED illumination platform of claim 1, wherein m=6, n=4, X=350, Y=500, Z=700.

18. The LED illumination platform of claim 1, wherein m=6, n=4, X=500, Y=700, Z=1000.

19. The LED illumination platform of claim 1, wherein m=6, n=4, X=700, Y=1000, Z=1400.

20. The LED illumination platform of claim 1, wherein m=8, n=6, X=700, Y=1000, Z=1400.

21. The LED illumination platform of claim 1, wherein m=8, n=6, X=1000, Y=1400, Z=2000.

22. The LED illumination platform of claim 1, wherein the drive current is 530 mA.

23. The LED illumination platform of claim 1, wherein the drive current is 390 mA.

24. A LED illumination platform characterized in that:
the LED illumination platform has a form factor and is powered by a driving current, the LED illumination platform generates light within the range of X±10% lumens while driven by the drive current if the LED illumination platform comprises n units of first LEDs and the LED illumination platform generates light within the range of Y±10% lumens while driven by the drive current if the LED illumination platform comprises m units of the first LEDs; wherein if the LED illumination platform comprises n units of second LEDs the LED illumination platform generates light within the range of Y±10% lumens while driven by the drive current, and if the LED illumination platform comprises m units of the second LEDs the LED illumination platform generates light within the range of Z±10% lumens while driven by the drive current; wherein m>n, Z>Y, Y>X, and the luminous efficiency of the second LED is higher than that of the first LED,
wherein the form factor comprises:
a heat-pipe having a flat portion and a contact portion;
a carrier with a opening accommodating the heat-pipe, the carrier having a first surface which is coplanar with the surface of the flat portion of the heat-pipe;
a heat-dissipating component having a plurality of fins, and the heat-dissipating component coupling the contact portion of the heat-pipe;
an energy converter being contacted with the flat portion and accommodate the first LEDs or the second LEDs, the energy converter is fixed on the carrier to contact with the flat portion; and
a panel with a hole corresponding to the energy converter, the heat pipe and the heat-dissipating component disposed in one side of the panel, and the light emitted from the energy converter projecting toward the other side of the panel.
